(19) United States
(12) Patent Application Publication
(10) Pub. No.: US 2025/0371238 A1
(43) Pub. Date: Dec. 4, 2025

(54) METHOD FOR OPTIMIZING ANALOG CIRCUIT USING ELECTRICAL DESIGN VARIABLES BASED ON REINFORCEMENT LEARNING AND SYSTEM FOR PERFORMING THE SAME

(71) Applicant: POSTECH RESEARCH AND BUSINESS DEVELOPMENT FOUNDATION, Pohang-si (KR)

(72) Inventors: Seok Hyeong KANG, Pohang-si (KR); Young Chang CHOI, Pohang-si (KR); Kyong Su LEE, Pohang-si (KR); Min Jeong CHOI, Pohang-si (KR)

(21) Appl. No.: 18/926,778

(22) Filed: Oct. 25, 2024

(30) Foreign Application Priority Data
May 30, 2024 (KR) 10-2024-0070997

(51) Int. Cl. G06F 30/373; G06F 119/02

(52) U.S. Cl. CPC G06F 30/373; G06F 2119/02

(57) ABSTRACT

A method for optimizing an analog circuit based on electrical design variables of the analog circuit and using reinforcement learning includes: performing a first sensitivity analysis on a first state of the analog circuit, which includes the electrical design variables; generating an action by inputting the first state, after performing the first sensitivity, analysis into an actor network; receiving, from the analog circuit, a second state and a first reward for the analog circuit as changed by the generated action; sampling a buffer that includes the electrical design variables and a first tuple according to predetermined criteria; evaluating a value of the action by inputting the second state, the sampled first tuple, and the first reward into a critic network; and identifying amount of change in the electrical design variable based on the first sensitivity analysis and training the critic network using the change amount in the electrical design variable.

### CROSS-REFERENCE TO RELATED APPLICATION

This application claims priority under 35 U.S.C § 119 to Korean Patent Application No. 10-2024-0070997 filed on May 30, 2024, in the Korean Intellectual Property Office, the entire contents of which are hereby incorporated by reference.

### TECHNICAL FIELD

The present disclosure relates to a method for optimizing an analog circuit using electrical design variables based on reinforcement learning and a system for performing the same. Specifically, the present disclosure relates to a method for optimizing an analog circuit by analyzing the sensitivity of transconductance to direct current, training actor and critic networks, and sampling generated tuples to optimize the performance of the analog circuit.

### BACKGROUND

This research was conducted under “2022M3H4A1A04096496, Future Technology Laboratory (Ternary)” and “No. RS-2023-00222085, Memory Module and Memory Compiler Development for Nonvolatile PIM”.

The content described in this section simply provides background information for the present disclosure and does not constitute the prior art.

Electronic design automation (EDA) may be used to automate the circuit design process for the design of a digital circuit. On the other hand, the design of the analog circuit should consider the relationship between design variables and circuit performance based on a lot of knowledge and experience. In other words, the analog circuit have high nonlinearity and wide design space, making it difficult to automate the circuit design process.

Accordingly, in order to reduce the time required for the analog circuit design process, there was a need to optimize analog circuit design using reinforcement learning (RL).

### SUMMARY

An object of the present disclosure is to provide a method for optimizing an analog circuit that allows for circuit design considering the short-channel effects using electrical design variables in the design of the analog circuit.

In addition, an object of the present disclosure is to provide a method for optimizing an analog circuit that may reduce the state space and easily find a target design.

In addition, an object of the present disclosure is to provide a method for optimizing an analog circuit that enables fast convergence by utilizing sensitivity analysis in reinforcement learning.

The objects of the present disclosure are not limited to the above-mentioned objects, and other objects and advantages of the present disclosure that are not mentioned will be understood by the following description and will be more clearly understood by embodiments of the present disclosure. In addition, it will be easy to see that the objects and advantages of the present disclosure may be realized by the means and combinations thereof disclosed in the claims.

According to some aspects of the disclosure, a method for optimizing an analog circuit based on electrical design variables of the analog circuit and using reinforcement learning, the method comprising: performing a first sensitivity analysis on a first state of the analog circuit, which includes the electrical design variables; generating an action by inputting the first state, after performing the first sensitivity, analysis into an actor network; receiving, from the analog circuit, a second state and a first reward for the analog circuit as changed by the generated action; sampling a buffer that includes the electrical design variables and a first tuple according to predetermined criteria; evaluating a value of the action by inputting the second state, the sampled first tuple,, and the first reward into a critic network; and identifying amount of change in the electrical design variable based on the first sensitivity analysis and training the critic network using the amount of change in the electrical design variable.

According to some aspects, the first tuple includes the first state, the second state, the first reward, and a first target embedding the first state.

According to some aspects, the performing the first sensitivity analysis includes: determining relationships between (a) amounts of change in a plurality of operational targets for performance of the analog circuit and (b) amounts of change in the electrical design variables, and generating a matrix that includes relationships between the electrical design variables and the plurality of operational targets.

According to some aspects, the matrix includes proportional relationships between (i) current values of the plurality of operational targets with respect to the amounts of change of the plurality of operational targets and (ii) values of the electrical design variables of the first state with respect to the amounts of change in the electrical design variables.

According to some aspects, the plurality of operational targets includes at least one of gain, power, phase margin, correction time, unit gain frequency (UGF), or in-phase signal removal ratio (CMRR) of the analog circuit.

According to some aspects, the electrical design variables include a ratio of transconductance to the direct current of the analog circuit.

According to some aspects, the electrical design variables further include a length of the analog circuit, and a width of the analog circuit is derivable from a relationship between the length and the ration of the transconductance to the direct current.

According to some aspects, the electrical design variables further include at least one of a bias voltage, a bias current, a remaining resistance, and a capacity of the analog circuit.

According to some aspects, the generating the action includes: inputting, into the actor network, a first amount of change equal to the difference between the target values of the electrical design variables and the first state, and generating, by the actor network, the action within a predetermined range.

According to some aspects, the evaluating the value of the action includes: generating a first target in which the first state and the second state are represented by one vector, connecting the first state with the first target, and inputting the connected first state and the first target into the critic network.

According to some aspects, the sampling the buffer includes: sorting the plurality of tuples including the first tuple according to the predetermined criteria, sampling a first portion of the plurality of sorted tuples to generate first sampling data, sampling a second portion of the plurality of tuples to generate second sampling data, the second portion excluding the first portion, and combining the first sampling data and the second sampling data to generate the sampling data.

According to some aspects, the sorting the plurality of tuples includes sorting the plurality of tuples based on a length of the analog circuit.

According to some aspects, the sorting the plurality of tuples includes sorting the plurality of tuples based on a ratio of a width of the analog circuit to a length of the analog circuit.

According to some aspects of the disclosure, an electronic device for optimizing an analog circuit, the electronic device comprises: a processor, and a memory operatively connected to the processor, wherein the memory stores instructions that, when executed by the processor, cause the processor, to perform a first sensitivity analysis of a first state of the analog circuit that includes electrical design variables, to generate an action by inputting the first state, after performing the first sensitivity analysis into an actor network, to receive, from the analog circuit, a second state and a first reward for the analog circuit as changed by the generated action, to sample a buffer that includes the electrical design variables and a first tuple according to predetermined criteria, to evaluate the value of the action by inputting the second state, the sampled first tuple, and the first reward, into a critic network, and to identify amount of change in the electrical design variable based on the first sensitivity analysis and training the critic network using the amount of change in the electrical design variable.

According to some aspects, the first tuple includes the first state, the second state, the first reward, and a first target embedding the first state.

According to some aspects, wherein in order to perform the first sensitivity analysis, the instructions instruct the processor: to determine relationships between (a) amounts of change in a plurality of operational targets for performance of the analog circuit and (b) amounts of change in the electrical design variables, and to generate a matrix including relationships between the electrical design variables and the plurality of operational targets.

According to some aspects, the matrix includes proportional relationships between (i) current values of the plurality of operational targets with respect to the amounts of change of the plurality of operational targets and (ii) values of the electrical design variables of the first state with respect to the amounts of change in the electrical design variables.

According to some aspects, the plurality of operational targets includes at least one of gain, power, phase margin, correction time, unit gain frequency (UGF), or in-phase signal removal ratio (CMRR) of the analog circuit.

According to some aspects, the electrical design variables include a ratio of transconductance to direct current of the analog circuit.

According to some aspects, the electrical design variables further include a length of the analog circuit, and a width of the analog circuit is derivable from a relationship between the length and ratio of the transconductance to the direct current.

Aspects of the disclosure are not limited to those mentioned above and other objects and advantages of the disclosure that have not been mentioned can be understood by the following description and will be more clearly understood according to embodiments of the disclosure. In addition, it will be readily understood that the objects and advantages of the disclosure can be realized by the means and combinations thereof set forth in the claims.

A method for optimizing an analog circuit according to some embodiments of the present disclosure may perform reinforcement learning using electrical design variables directly related to analog circuit performance and determine the operating area of the analog circuit for the target performance, thereby providing a method for optimizing an analog circuit in which the operation of the analog circuit is intuitively determined in a process affected by short-channel effects.

Additionally, the present disclosure may provide a method for optimizing an analog circuit with improved accuracy and reduced errors by predicting the next state within a given range by training the agent using the amounts of change in electrical design variables calculated through sensitivity analysis.

In addition, the present disclosure may provide a method for optimizing an analog circuit by improving the efficiency of reinforcement learning through sorting multiple tuples based on criteria related to analog circuit performance and sampling some of them.

In addition to the above description, the specific effects of the present disclosure will be described together with the detailed description for implementing the present disclosure.

### BRIEF DESCRIPTION OF THE DRAWINGS

FIG. 1 is a diagram illustrating a hardware configuration of a system for performing a method for optimizing an analog circuit according to some embodiments of the present disclosure.

FIG. 2 is a flowchart illustrating a method for optimizing an analog circuit of FIG. 1 in detail.

FIG. 3 is a block diagram illustrating a method for optimizing an analog circuit of FIG. 1 in detail.

FIG. 4 is a diagram illustrating structures of the actor network and the critic network of FIG. 2.

FIG. 5 is a flowchart illustrating performing the first sensitivity analysis of FIG. 2.

FIG. 6 is a diagram illustrating a relationship between electrical design variables and an analog circuit of FIG. 5.

FIG. 7 is a diagram illustrating an operational target of the analog circuit of FIG. 5.

FIG. 8 is a diagram illustrating the amounts of change in electrical design variables of FIG. 5.

FIG. 9 is a flowchart illustrating a process of generating the action of FIG. 2.

FIG. 10 is a flowchart illustrating a process of evaluating the value of the action of FIG. 2.

FIG. 11 is a flowchart illustrating a process of sampling the buffer of FIG. 2.

FIG. 12 is a diagram illustrating the sampling of FIG. 11.

FIG. 13 is an example of a circuit illustrating the optimization efficiency of the analog circuit.

FIG. 14 is a table showing target and resulting performance for each circuit in FIG. 13.

FIG. 15 is a graph showing the resulting performance of FIG. 14 and the efficiency of each method.

FIG. 16 is a table showing the efficiency of each method in FIG. 15.

### DETAILED DESCRIPTION OF THE PREFERRED EMBODIMENTS

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since one or more embodiments described herein and the configurations illustrated in the drawings are examples in which the disclosure is realized and do not represent all the technical implementations of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

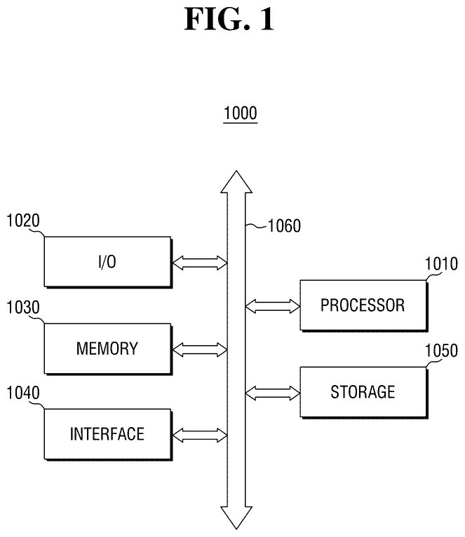

Hereinafter, a method for optimizing an analog circuit and a system for performing the same according to some embodiments of the present disclosure will be described in detail with reference to FIGS. 1 to 16.

FIG. 1 is a diagram illustrating a hardware configuration of a system for performing a method for optimizing an analog circuit according to some embodiments of the present disclosure.

Referring to FIG. 1, the system for performing the method for optimizing the analog circuit according to some embodiments of the present disclosure may be implemented as an electronic device 1000. The electronic device 1000 may include a processor 1010, an input/output (I/O) device 1020, a memory 1030, an interface 1040, a storage 1050, and a bus 1060. The processor 1010, the input/output device 1020, the memory 1030, the interface 1040, and/or the storage 1050 may be coupled to each other through a bus 1060. The bus 1060 corresponds to a path through which data are moved.

Specifically, the processor 1010 may include at least one of a central processing unit (CPU), a microprocessor unit (MPU), a micro controller unit (MCU), a graphic processing unit (GPU), a microprocessor, a digital signal processor, a microcontroller, an application-specific integrated circuit (ASIC), a financial application processor (AP), and logical elements capable of performing similar functions thereto.

The input/output device 1020 may include at least one of a keypad, a keyboard, a touch screen, and a display device.

The memory 1030 may load data and/or programs. In this case, the memory 1030 may be an operational memory for improving the operation of the processor 1010, and may include a high-speed DRAM and/or SRAM. The memory 1030 may include one or more volatile memory devices such as a double data rate static DRAM (DDR SDRAM), a single data rate SDRAM (SDR SDRAM), and/or one or more nonvolatile memory devices such as an electrical erasable programmable ROM (EEPROM) and a flash memory.

The interface 1040 may perform a function of transmitting data to a communication network or receiving data from the communication network. The interface 1040 may be in a wired or wireless form. For example, the interface 1040 may include an antenna, a wired/wireless transceiver, or the like.

The storage 1050 may store and archive data and/or programs. The storage 1050 may include one or more nonvolatile memory devices such as a solid state drive (SSD), a hard drive, and a flash memory. In the present disclosure, the storage 1050 may store a computer program composed of instructions for performing the above-described method for providing persona code.

The system may be applied to a personal digital assistant (PDA), a portable computer, a web tablet, a wireless phone, a mobile phone, a digital music player, a memory card, or any electronic product capable of transmitting and/or receiving information in a wireless environment.

In addition, the system according to embodiments of the present disclosure may be a system formed by connecting a plurality of electronic devices 1000 to each other through a network. In this case, each module or combination of modules may be implemented as the electronic device 1000. However, the present disclosure is not limited thereto.

Additionally, the system may be implemented with at least one of a workstation, a data center, an internet data center (IDC), a direct attached storage (DAS) system, a storage area network (SAN) system, a network attached storage (NAS) system, and a redundant array of inexpensive disks, or redundant array of independent disks (RAID) system, but the present disclosure is not limited thereto.

In addition, the system may transmit data over the network. The network may include a network by wired internet technology, wireless internet technology, and local area network technology. The wired internet technology may include at least one of, for example, a local area network (LAN) and a wide area network (WAN).

For example, the wireless internet technology may include at least one of Wireless LAN (WLAN), Digital Living Network Alliance (DLNA), Wireless Broadband (Wibro), World Interoperability for Microwave Access (Wimax), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), and 5G New Radio (NR) technology. However, the present disclosure is not limited thereto.

For example, the short-range communication technology may include at least one of Bluetooth, Radio Frequency Identification (RFID), Infrared Data Association (IrDA), Ultra-(USC), Wideband (UWB), ZigBee, Near Field Communication (NFC), Ultra Sound Communication Visible Light Communication (VLC), Wi-Fi, Wi-Fi Direct, and 5G New Radio (NR). However, the present disclosure is not limited thereto.

A system communicating through a network may comply with a technical standard and a standard communication method for mobile communication. For example, the standard communication method may include at least one of Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTEA), and 5G New Radio (5G NR). However, the present disclosure is not limited thereto.

Hereinafter, a configuration of a system for performing a method for optimizing an analog circuit will be described in detail.

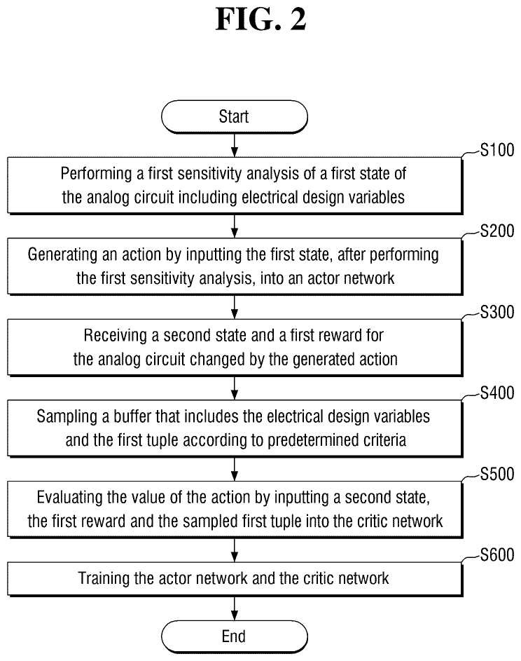

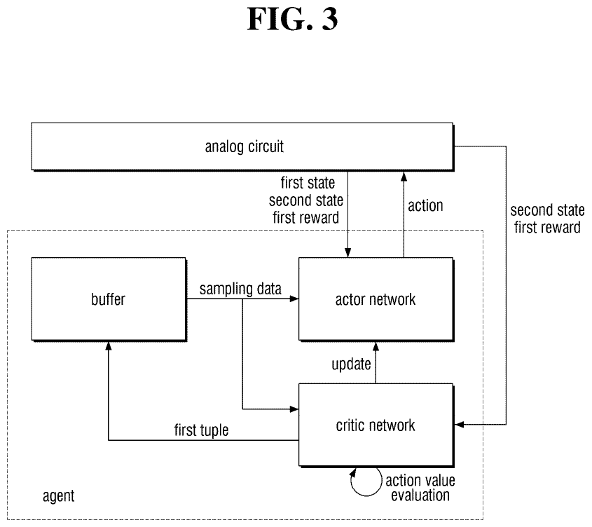

FIG. 2 is a flowchart illustrating a method for optimizing an analog circuit of FIG. 1 in detail. FIG. 3 is a block diagram illustrating a method for optimizing an analog circuit of FIG. 1 in detail. Hereinafter, it will be described as an example that the method for optimizing the analog circuit according to some embodiments of the present disclosure is performed by the processor 1010 described above.

The processor 1010 is configured for performing the method for optimizing the analog circuit according to some embodiments of the present disclosure. However, the present disclosure is not limited thereto.

In some embodiments of the present disclosure, the processor 1010 may perform a first sensitivity analysis of a first state of the analog circuit that includes electrical design variables (S100). The processor 1010 may receive the first state of the analog circuit from the analog circuit and perform the first sensitivity analysis based on the first state.

Specifically, the first state may refer to a state of the analog circuit before performing reinforcement learning. The first state may include the electrical design variables of the analog circuit.

The electrical design variables may include a ratio of transconductance to direct current of the analog circuit. That is, the processor 1010 may determine the size of the circuit by using the ratio of the transconductance to the direct current. In addition, the electrical design variables may include a bias voltage, a bias current, a remaining resistance, and a capacity of the analog circuit. The electrical design variables will be described in detail later.

Subsequently, an action may be generated by inputting the first state, after performing the first sensitivity analysis, into an actor network (S200). The processor 1010 may identify the action generated by the actor network. For example, the actor network may generate the action based on the first state received from the processor 1010.

Specifically, the processor 1010 may include an agent. The agent may include an actor network, a critic network, and a buffer. The actor network may transmit the action to the analog circuit.

Subsequently, a second state and a first reward for the analog circuit changed by the generated action may be received (S300). Specifically, the second state may refer to a state of the analog circuit after performing reinforcement learning. In this case, the second state may refer to a state of the electrical design variables which is the same as the first state.

Subsequently, a buffer including the electrical design variables and the first tuple may be sampled according to predetermined criteria (S400). The critic network may receive the sampled first tuple from the buffer. The buffer may be sampled by processor 1010.

Subsequently, the value of the action may be evaluated by inputting a second state, the first reward and the sampled the first tuple into the critic network (S500). The processor 1010 may identify the sampled first tuple. The processor 1010 may transmit the sampled first tuple, the first reward and the second state into the critic network so that the value of the action may be evaluated by critic network. The critic network may input the action into the analog circuit. The processor 1010 may identify the value of the action from the critic network.

The first tuple may include a first state, a second state, a first reward, and a first target embedding the first state. The first reward may mean a value obtained by subtracting the predicted value for the first state from the predicted value for the second state. The predicted value for the second state may be the predicted value of the electrical design variables in the second state. The predicted value for the first state may be the predicted value of the electrical design variables in the first state.

Furthermore, the critic network may evaluate the value of the action. Subsequently, the critic network may update the actor network. In this case, the actor network may generate an action with the updated content. Furthermore, the critic network may transfer the first tuple to the buffer. The buffer may store the first tuple. The processor 1010 can cause the actor network to be updated by the critic network.

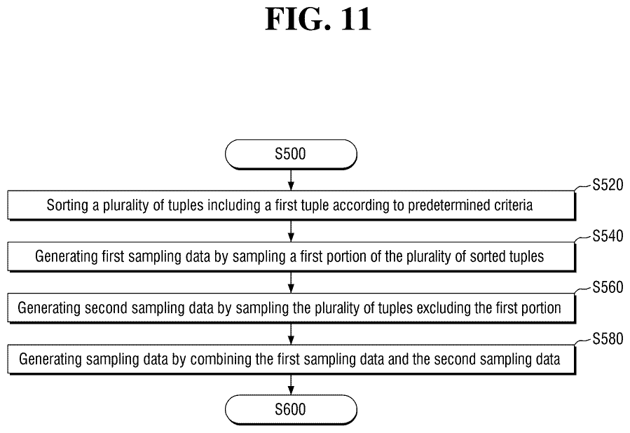

Specifically, the buffer may transfer the sampling data to the actor network and the critic network. Details of sampling the buffer will be described below with reference to FIG. 11.

Subsequently, the amount of change in the electrical design variables is identified based on the first sensitivity analysis, and the critic network can be trained using the amount of change in the electrical design variables. (S600). The second sensitivity analysis may be performed in the same manner as the first sensitivity analysis described above. In accordance with some embodiments, the operation at S600 means that one or more or all of the operations S100-S500 is/are repeatedly performed in each of a plurality of iterations (or simulations) until a convergence is achieved, i.e., until a reinforcement learning result is obtained. In some embodiments, the actor network can be trained using the amount of change in the electrical design variables.

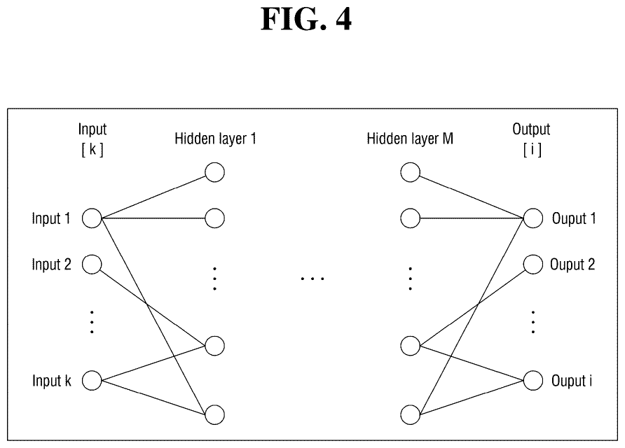

FIG. 4 is a diagram illustrating structures of the actor network and the critic network of FIG. 2.

Referring to FIGS. 2 and 4, the actor network used in some embodiments of the present disclosure may output an action on input data using an artificial neural network trained based on big data.

The actor network may be implemented as a deep learning module to perform artificial neural network learning by using mapping data for separate parameters derived based on input data. In this case, the deep learning module may perform machine learning on parameters input as learning factors.

In more detail, deep learning technology, a type of machine learning, is learning by going down to a deep level in multiple stages based on data.

Deep learning represents a set of machine learning algorithms that extract core data from a plurality of data while increasing the step.

The actor network may use various known deep learning structures. For example, an actor network may utilize structures such as a convolutional neural network (CNN), a recurrent neural network (RNN), a deep belief network (DBN), and a graph neural network (GNN).

On the other hand, the artificial neural network learning of the actor network may be accomplished by adjusting a weight of a connecting line between the nodes (and also adjusting a bias value if necessary) to produce a desired output for a given input. In addition, the artificial neural network may continuously update the weight value by learning. In addition, methods such as back propagation may be used for learning the artificial neural network.

In this case, the memory 1030 of the system may be equipped with an artificial neural network pre-trained through machine learning. That is, data, result data, and the like used for machine learning may be stored in the memory 1030.

In some embodiments of the present disclosure, the actor network may include a transformer including an encoder EN and a decoder DE, or an autoencoder-based deep learning model. However, these are only some examples of the present disclosure, and the present disclosure is not limited thereto.

Referring to FIG. 4, the actor network includes an input layer using sampling data as an input node, an output layer using an action as an output node, and M hidden layers disposed between the input layer and the output layer.

Here, a weight may be set at an edge connecting nodes of each layer. The presence or absence of such a weight or edge may be added, removed, or updated in the learning process. Therefore, the weights of nodes and edges arranged between k input nodes and i output nodes may be updated through the learning process.

In the actor network, all nodes and edges may be set to initial values before performing learning. However, when information is cumulatively input, the weights of nodes and edges change, and in this process, a match may be made between parameters input as learning factors (i.e., sampling data) and values assigned to output nodes (i.e., action).

Additionally, when a cloud server (not shown) is used, the actor network may receive and process a large number of parameters. Thus, the actor network may perform learning based on large amounts of data.

The weights of nodes and edges between the input node and the output node constituting the actor network may be updated by the learning process of the actor network. In addition, the parameters output from the actor network may be further extended to various data in addition to the summary data.

Both semi-supervised learning and supervised learning may be used as machine learning methods used in the actor network. Moreover, the actor network may be controlled to automatically update the artificial neural network structure for outputting more accurate summary data after learning depending on the settings.

Additionally, although not clearly shown in the drawing, in some other embodiments of the present disclosure, the operation of the actor network may be performed in connection with the server 100 or a separate cloud server (not shown).

In addition, the critic network according to some embodiments of the present disclosure may use an artificial neural network trained based on big data, such as the actor network. However, the critic network includes an input layer using sampling data as an input node, an output layer using an action as an output node, and M hidden layers disposed between the input layer and the output layer. The processor 1010 can cause the second state and the first reward to be inputted into the critic network from the analog circuit for updating the action.

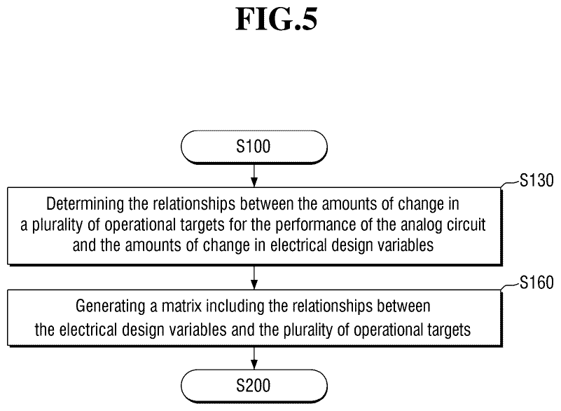

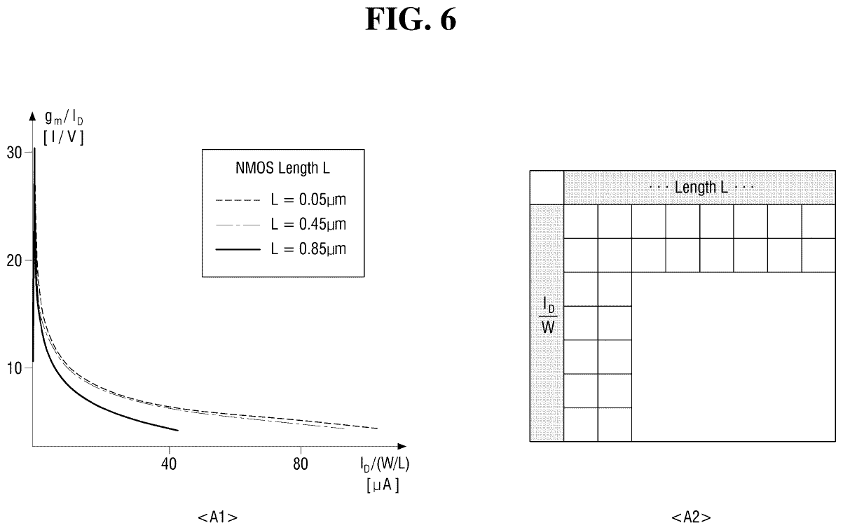

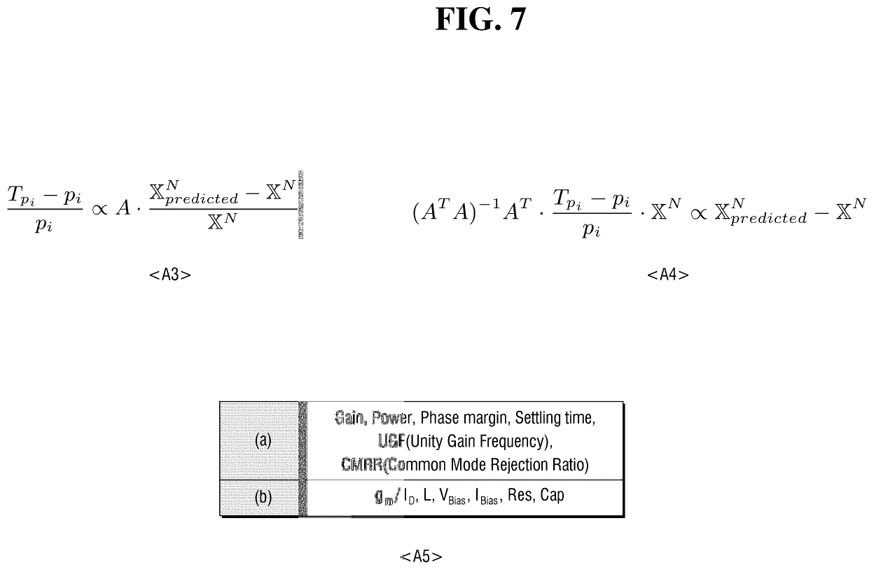

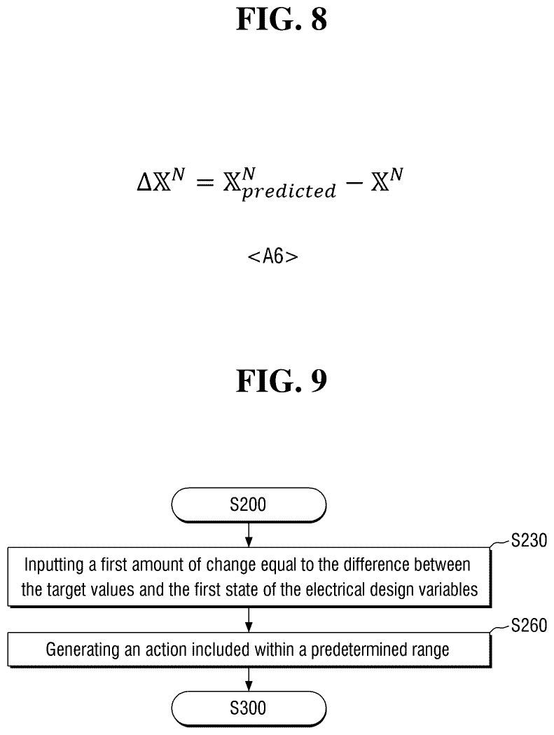

FIG. 5 is a flowchart illustrating performing the first sensitivity analysis of FIG. 2. FIG. 6 is a diagram illustrating a relationship between electrical design variables and an analog circuit of FIG. 5. FIG. 7 is a diagram illustrating an operational target of the analog circuit of FIG. 5. FIG. 8 is a diagram illustrating the amounts of change in electrical design variables of FIG. 5.

Referring to FIG. 5, the first sensitivity analysis may determine a relationship between the amounts of change in a plurality of operational targets for the performance of the analog circuit and the amounts of change in electrical design variables (S130).

Subsequently, a matrix including a relationship between the electrical design variables and the plurality of operational targets may be generated (S160).

Referring to FIG. 6, <A1> is a graph showing experimental values of direct current with respect to an aspect ratio, and a ratio of transconductance to direct current. <A1> may mean an experimental value for a single NMOS. <A2> may represent a lookup table that associates the length L of the NMOS (as an example of an analog circuit) with the width W of the NMOS and the direct current I_{D} of the NMOS. Meanwhile, the lookup table may include experimental values for a single PMOS. However, embodiments of the present disclosure are not limited thereto. Here, L can be the length of the channel of the transistor (NMOS), and the W can be the width of the channel of the transistor (NMOS).

In this case, the aspect ratio may refer to a value of a width with respect to a length of an analog circuit. The size of the analog circuit may be determined using an aspect ratio. Since the direct current with respect to the aspect ratio is a normalized value, the width of the analog circuit may be determined when the length and the direct current value are provided.

Specifically, the value of a ratio gₘ/I_{D} of the transconductance gₘ to the direct current ID may represent the performance of the analog circuit. The ratio gₘ/I_{D} is the one of the electrical design variables. In this case, when the value of the ratio of the transconductance to the direct current is set, the length and width of the analog circuit may be determined using the lookup table. That is, the lookup table may be a matrix capable of determining the width of the analog circuit when the value of the ratio of the transconductance to the direct current and the length of the analog circuit are known.

In addition, the value of the ratio of the transconductance to the direct current may be determined according to the target performance. Specifically, if it is aimed to operate at low power in a region with weak inversion, the value of the ratio of the transconductance to the direct current may be set large. On the other hand, if it is aimed to operate at high speed in a region with strong inversion, the value of the ratio of the transconductance to the direct current may be set to be small.

Referring to FIGS. 3 and 7, the electrical design variables may be associated with the amounts of change in the plurality of operational targets for the performance of the analog circuit. <A3> may include a relational equation between the operational target and the electrical design variables for the performance of the analog circuit. <A4> may include an equation for calculating the amounts of change in the electrical design variables from the relational equation of <A3>. <A5> may include the performance and the electrical design variables of the analog circuit of <A3>.

Specifically, <A3> may represent the sensitivity analysis on the electrical design variables. That is, matrix A of <A3> may mean a sensitivity analysis matrix of the operational target for the performance of the analog circuit with respect to the electrical design variables. In other words, matrix A may express how sensitive the operational target for the performance of the analog circuit is to the electrical design variables.

In this case, the sensitivity analysis may use a method that may be measured in a nonlinear environment. The sensitivity analysis may use, for example, a Sobol method that analyzes the degree to which input variables contribute to the overall output variance. However, embodiments of the present disclosure are not limited thereto.

In addition, the amount of change in the operational target may mean a difference between a target value (Tₚ_{ᵢ}) of the operational target and a current value (pᵢ) of the operational target. The amounts of change in the electrical design variables may mean differences between predicted values

$$( {𝕏}_{p redicted}^{N} )$$

of the electrical design variables in a state predicted to reach the target value of the operational target and current values ( [symbol] ^{N}) of the electrical design variables. In this case, the current values of the electrical design variables may include a first state. i is the ordinal of the component of each vector of the target value and the current value, and N can be the dimension of each vector of the predicted values and the current values.

In this case, the amount of change in the operational target and the amounts of change in the electrical design variables may have proportional relationships. Specifically, matrix A may represent proportional relationships between the amounts of change in the operational targets and the amounts of change in the electrical design variables. That is, matrix A may include the proportional relationships between the current values of the operational targets and the values of the electrical design variables in the first state with respect to the amounts of change in the electrical design variables.

In <A4>, the amounts of change in the electrical design variables may be derived by applying matrix A and the operational targets to the current values of the electrical design variables. That is, after performing the sensitivity analysis, operations involving matrix A and the operational targets may be performed on the current values of the electrical design variables.

In addition, (a) of <A5> may include the plurality of operational targets for the performance of the analog circuit. Specifically, the plurality of operational targets may include at least one of gain, power, phase margin, setting time, unit gain frequency (UGF), and common mode rejection ratio (CMRR) of an analog circuit.

(b) of <A5> may include the electrical design variables. The electrical design variables may include the value of a ratio gₘ/I_{D} of the transconductance gm to the direct current I_{D} (gₘ/I_{D}). In addition, the electrical design variables may include a length (L), a bias voltage (V_{Bias}), a bias current (I_{Bias}), a remaining resistance (Res), and a capacity (Cap) of the analog circuit.

Meanwhile, <A6> is intended to explain the amounts of change in electrical design variables of <A3>, and the change in electrical design variables may represent the operating target. That is, after matrix A and the operational targets are calculated, the amounts of change in the electrical design variables may be input to the actor network to be trained. Using <A3>, it can be determined how much <A6> needs to be changed to achieve the operational targets. The change amount Δ [symbol] ^{N}, which is the result of <A6>, can be input into the actor network so that the actor network can be trained. In this case, matrix A may represent a proportional relationship between one electrical design variable and the operational targets. However, embodiments of the present disclosure are not limited thereto.

FIG. 9 is a flowchart illustrating a process of generating the action of FIG. 2.

Referring to FIG. 9, a first amount of change equal to the difference between the target values and the first state of the electrical design variables may be input into the actor network (S230).

Subsequently, an action included within a predetermined range may be generated by the actor network (S260). The range of the action may be predetermined by the user. For example, the range of the action may be set to a value between −1 and 1 for each electrical design variable.

Through this, the present disclosure may perform reinforcement learning using the electrical design variables directly related to analog circuit performance and determine the operation area of the analog circuit for target performance, thereby providing a method for optimizing an analog circuit where the operation of the analog circuit is intuitively determined in a process that must take short channel effects into account.

Additionally, the present disclosure may provide a method for optimizing an analog circuit with improved accuracy and reduced errors by predicting the next state within a given range by training the agent using the amounts of change in electrical design variables calculated through sensitivity analysis.

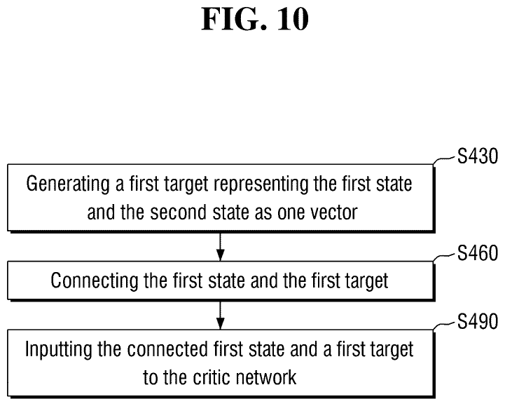

FIG. 10 is a flowchart illustrating a process of evaluating the value of the action of FIG. 2.

Referring to FIG. 10, a first target representing the first state and the second state as one vector may be generated (S430). In addition, the first target may represent the plurality of electrical design variables as one vector.

Subsequently, the first state and the first target may be connected (S460). In this case, the first target may be included in the first state. That is, the first target may be defined as a subset of the first state. The processor 1010 may identify the connected first state and the first target. For example, the first state and the first target may be connected by machine learning algorithms.

Subsequently, the connected first state and a first target may be input to the critic network (S490). The critic network may reduce the dimension of the input by learning the connected first state and the first target. The connection between the first state and the first target may be a vector serving as a flag of learning. Based on sampled data according to a fixed size, the actor network and crit network are updated using Deep Deterministic Policy Gradient (DDPG), a reinforcement learning methodology.

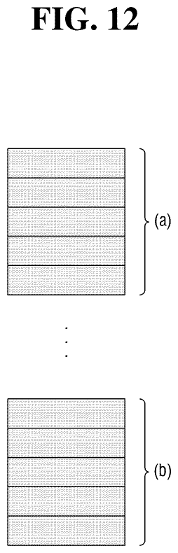

FIG. 11 is a flowchart illustrating a process of sampling the buffer of FIG. 2. FIG. 12 is a diagram illustrating the sampling of FIG. 11.

Referring to FIGS. 11 and 12, a plurality of tuples including a first tuple may be sorted according to predetermined criteria (S520). For example, the first tuple may include the first state of the analog circuit, the second state of the analog circuit, a first reward, and the first target embedding the first state. Similarly, each tuple of the plurality of tuples includes a current state of the analog circuit, a next state of the analog circuit, a corresponding reward based on the current state and the next state, and a corresponding target embedding the current state. The plurality of tuples is obtained through a plurality of iterations (or simulations) in each of which the current state of the analog circuit is output from the analog circuit to the actor network, and a corresponding action is output from the actor network to the analog circuit resulting in a next state of the analog circuit being output to the critic network (and also to the actor network as the current state for a next iteration (or next simulation)).

Subsequently, first sampling data may be generated by sampling a first portion of the plurality of sorted tuples (S540).

Subsequently, second sampling data may be generated by sampling a second portion of the plurality of tuples, the second portion excluding (e.g., non-overlapping with) the first portion (S560).

Specifically, the plurality of tuples may be sorted based on the length of the analog circuit. That is, the predetermined criteria may be the length of the analog circuit. In this case, the predetermined criteria may involve pick sampling. Pick sampling may affect power and speed because the gain value is roughly proportional to the length of the analog circuit.

Sorting the plurality of tuples may include sorting the plurality of tuples based on the length of the analog circuit. In FIG. 12, (a) may refer to first sampling data, and (b) may refer to a second sampling of data. According to pick sampling, the first sampling data may include an upper part of the plurality of tuples sorted by the length of the analog circuit. On the other hand, the second sampling data may include a lower part of the plurality of tuples sorted by the length of the analog circuit. However, embodiments of the present disclosure are not limited thereto.

In some embodiments of the present disclosure, the predetermined criteria may be the aspect ratio of the analog circuit. In other words, the predetermined reference may be a ratio of the width of the analog circuit to the length of the analog circuit. In this case, the predetermined criteria may involve PZ sampling. With PZ sampling, the zeros and poles may be used to derive the gain and phase margin.

Sorting the plurality of tuples may include sorting the plurality of tuples based on the ratio of the width of the analog circuit to the length of the analog circuit. In FIG. 12, (a) may refer to the first sampling data, and (b) may refer to the second sampling data. According to PZ sampling, the first sampling data may include an upper part of the plurality of tuples sorted by the aspect ratio of the analog circuit. On the other hand, the second sampling data may include a lower part of the plurality of tuples sorted by the aspect ratio of the analog circuit. However, embodiments of the present disclosure are not limited thereto.

Meanwhile, the predetermined criteria may be a method of randomly sorting the plurality of tuples. Also, the first and second sampling data may be generated by randomly selecting non-overlapping sets of tuples among the plurality of tuples.

Subsequently, sampling data may be generated by combining the first sampling data and the second sampling data (S580). That is, the sampling data may be generated by combining the first sampling data and the second sampling data.

Accordingly, the present disclosure may provide a method for optimizing an analog circuit that improves the efficiency of reinforcement learning by sorting the plurality of tuples and sampling some of them based on criteria related to analog circuit performance.

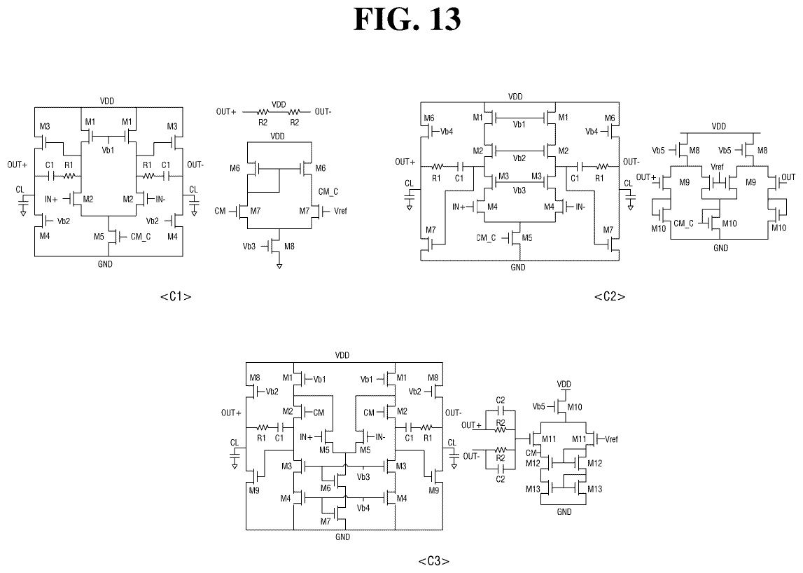

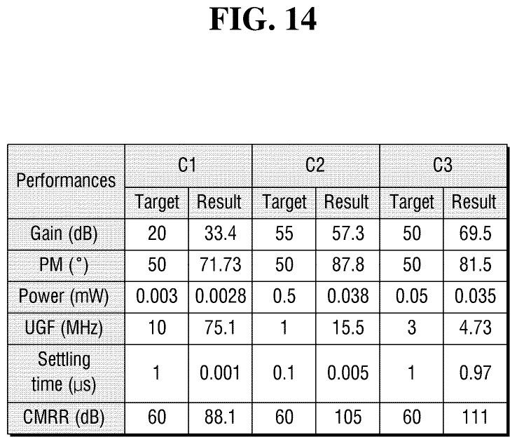

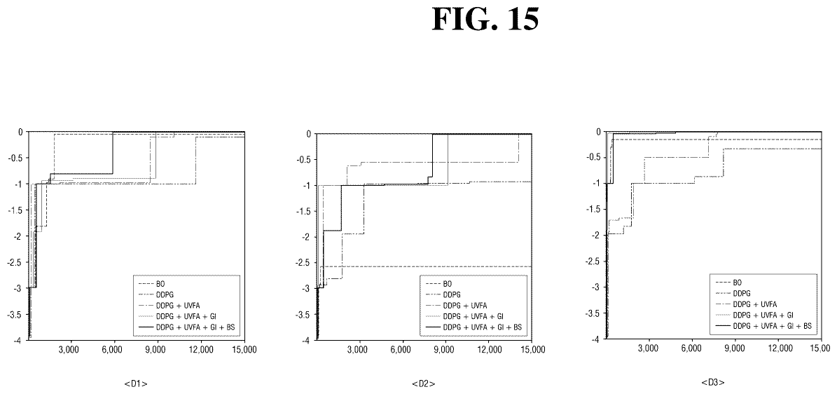

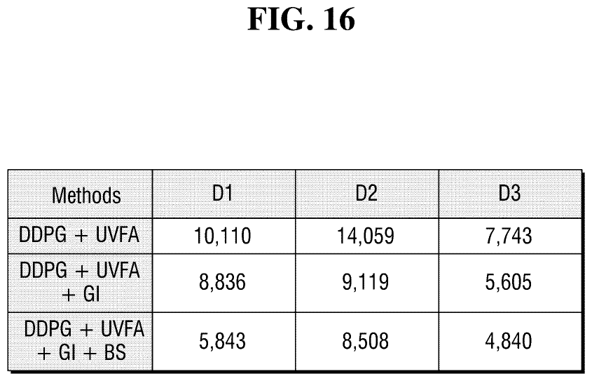

FIG. 13 is an example of a circuit illustrating the optimization efficiency of the analog circuit. FIG. 14 is a table showing target and resulting performance for each circuit in FIG. 13. FIG. 15 is a graph showing the resulting performance of FIG. 14 and the efficiency of each method. FIG. 16 is a table showing the efficiency of each method in FIG. 15.

Referring to FIGS. 13 to 16, it may be seen that the reinforcement learning results of the analog circuit C1 to C3 are shown to have better values than operational targets. For example, in FIG. 14, for each of analog circuits C1, C2, C3, gain, phase margin (PM), UGF, and CMRR, which are reinforcement learning results, may be greater than gain, phase margin, UGF, and CMRR, which are operational targets. On the other hand, power and settling time, which are reinforcement learning results, may be smaller than power and settling time which are operational targets. Therefore, the reinforcement learning results may have better performance than the operational targets. In addition, in FIGS. 15-16, D1 to D3 may represent the number of simulations of analog circuits C1 to C3 required to obtain the reinforcement learning results. When the electrical design variables and sampling are used, the number of simulations may be reduced. The x-axis is the number of episodes (the number of simulations), and the y-axis is the figure of merit (FoM) that defines the degree of optimization. The larger the value of the FoM, the better the circuit performance is predicted. To obtain the results in FIGS. 14, 15, and 16, we used three different operational amplifiers (OP Amp), C1, C2, and C3. D1 is the result of C1, D2 is the result of C2, and D3 is the result of C3.

In FIG. 15, Bo may refer to Bayesian Optimization, DDPG may refer to Deep deterministic Policy Gradient, UVFA may refer to Universal Value Function Approximators, GI may refer to learning using gm/I_{D}, and BS may refer to buffer sampling.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

What is claimed is:

1. A method for optimizing an analog circuit based on electrical design variables of the analog circuit and using reinforcement learning, the method comprising:
performing a first sensitivity analysis on a first state of the analog circuit, which includes the electrical design variables;
generating an action by inputting the first state, after performing the first sensitivity, analysis into an actor network;
receiving, from the analog circuit, a second state and a first reward for the analog circuit as changed by the generated action;
sampling a buffer that includes the electrical design variables and a first tuple according to predetermined criteria;
evaluating a value of the action by inputting the second state, the sampled first tuple,, and the first reward into a critic network; and
identifying amount of change in the electrical design variable based on the first sensitivity analysis and training the critic network using the amount of change in the electrical design variable.

2. The method of claim 1, wherein the first tuple includes the first state, the second state, the first reward, and a first target embedding the first state.

3. The method of claim 1, wherein the performing the first sensitivity analysis includes:
determining relationships between (a) amounts of change in a plurality of operational targets for performance of the analog circuit and (b) amounts of change in the electrical design variables, and generating a matrix that includes relationships between the electrical design variables and the plurality of operational targets.

4. The method of claim 3, wherein the matrix includes proportional relationships between (i) current values of the plurality of operational targets with respect to the amounts of change of the plurality of operational targets and (ii) values of the electrical design variables of the first state with respect to the amounts of change in the electrical design variables.

5. The method of claim 4, wherein the plurality of operational targets includes at least one of gain, power, phase margin, correction time, unit gain frequency (UGF), or in-phase signal removal ratio (CMRR) of the analog circuit.

6. The method of claim 1, wherein the electrical design variables include a ratio of transconductance to direct current of the analog circuit.

7. The method of claim 6, wherein the electrical design variables further include a length of the analog circuit, and a width of the analog circuit is derivable from a relationship between the length and the ratio of the transconductance to the direct current.

8. The method of claim 7, wherein the electrical design variables further include at least one of a bias voltage, a bias current, a remaining resistance, or a capacity of the analog circuit.

9. The method of claim 1, wherein the generating the action includes:
inputting, into the actor network, a first amount of change equal to a difference between target values of the electrical design variables and the first state, and generating, by the actor network, the action within a predetermined range.

10. The method of claim 1, wherein the evaluating the value of the action includes:
generating a first target in which the first state and the second state are represented by one vector, connecting the first state with the first target, and inputting the connected first state and the first target into the critic network.

11. The method of claim 1, wherein the sampling the buffer includes:
sorting the plurality of tuples including the first tuple according to the predetermined criteria, sampling a first portion of the plurality of sorted tuples to generate first sampling data, sampling a second portion of the plurality of tuples to generate second sampling data, the second portion excluding the first portion, and combining the first sampling data and the second sampling data to generate the sampling data.

12. The method of claim 11, wherein the sorting the plurality of tuples includes sorting the plurality of tuples based on a length of the analog circuit.

13. The method of claim 11, wherein the sorting the plurality of tuples includes sorting the plurality of tuples based on a ratio of a width of the analog circuit to a length of the analog circuit.

14. An electronic device for optimizing an analog circuit, the electronic device comprising:
a processor; and
a memory operatively connected to the processor, wherein the memory stores instructions that, when executed by the processor, cause the processor:
to perform a first sensitivity analysis of a first state of the analog circuit that includes electrical design variables, to generate an action by inputting the first state, after performing the first sensitivity analysis, into an actor network, to receive, from the analog circuit, a second state and a first reward for the analog circuit as changed by the generated action, to sample a buffer that includes the electrical design variables and a first tuple according to predetermined criteria;
to evaluate the value of the action by inputting the second state, the sampled first tuple, and the first reward, into a critic network, and to identify amount of change in the electrical design variable based on the first sensitivity analysis and training the critic network using the amount of change in the electrical design variable.

15. The electronic device of claim 14, wherein the first tuple includes the first state, the second state, the first reward, and a first target embedding the first state.

16. The electronic device of claim 14, wherein in order to perform the first sensitivity analysis, the instructions instruct the processor:
to determine relationships between (a) amounts of change in a plurality of operational targets for performance of the analog circuit and (b) amounts of change in the electrical design variables, and to generate a matrix including relationships between the electrical design variables and the plurality of operational targets.

17. The electronic device of claim 16, wherein the matrix includes proportional relationships between (i) current values of the plurality of operational targets with respect to the amounts of change of the plurality of operational targets and (ii) values of the electrical design variables of the first state with respect to the amounts of change in the electrical design variables.

18. The electronic device of claim 17, wherein the plurality of operational targets includes at least one of gain, power, phase margin, correction time, unit gain frequency (UGF), or in-phase signal removal ratio (CMRR) of the analog circuit.

19. The electronic device of claim 14, wherein the electrical design variables include a ratio of transconductance to direct current of the analog circuit.

20. The electronic device of claim 19, wherein the electrical design variables further include a length of the analog circuit, and a width of the analog circuit is derivable from a relationship between the length and the ratio of the transconductance to the direct current.
